(19) United States
(12) Patent Application Publication
(10) Pub. No.: US 2006/0237503 A1
(43) Pub. Date: Oct. 26, 2006

(54) Platform for pick-up truck

(76) Inventor: Marc Langelier, Ste-Christine (CA)

Correspondence Address: Eric Fincham, 316 Knowlton Road, Lac Brome, QC, J0E 1V0, CA

(21) Appl. No.: 11/399,191

(22) Filed: Apr. 6, 2006

(30) Foreign Application Priority Data
Apr. 8, 2005 (CA) 2,504,112

(51) Int. Cl. B60R 9/00

(52) U.S. Cl. 224/403

(57) ABSTRACT

A storage device for a pick-up truck having an open pick-up bed, the storage device comprising a frame sized to fit within the pick-up bed, an upper platform supported by the frame, at least one ramp, a storage compartment located below said upper platform for storing the ramp, and a tray below the storage compartment, the tray being slidably moveable between a storage position and an open position. The arrangement permits the truck to carry a recreational vehicle on the upper platform while providing for storage of tools and other requirements on the sliding tray.

### FIELD OF THE INVENTION

The present invention relates to vehicle accessories and more particularly, relates to a platform and storage area for use with pick-up trucks.

### BACKGROUND OF THE INVENTION

Pick-up truck storage boxes have been in use for many years in various shapes, sizes and materials. In general, such storage boxes allow the user to access the contents of the box from the top by standing at the side of the vehicle or climbing onto the bed of the vehicle.

Frequently, pick-up trucks are employed to transport various types of recreational vehicles from one location to another. In such instances, the recreational vehicle is usually driven onto the truck bed. In so doing, there is no storage space remaining.

### SUMMARY OF THE INVENTION

It is an object of the present invention to provide a storage device for a pick-up truck and which device is designed to receive a recreational vehicle while providing storage space.

According to one aspect of the present invention, there is provided a storage device for a pick-up truck having an open pick-up bed, the storage device comprising a frame sized to fit within the pick-up bed, an upper platform supported by the frame, at least one ramp, a storage compartment below the upper platform for storing the at least one ramp and a tray below the storage compartment, the tray being slidably moveable between a storage position and an open position.

The device of the present invention, as above mentioned, will include a frame which is designed to sit within the box of the pick-up truck. The frame will include suitable horizontal and vertical members and will provide an upper platform upon which a recreational vehicle may be placed and a lower portion which is designed to receive at least one sliding tray.

The upper platform preferably has, on a bottom surface thereof, a compartment which is designed to retain one or more ramps. The ramps are utilized for permitting the recreational vehicle to embark/disembark from the upper platform. Naturally, a single wider ramp may be utilized if so desired.

In a preferred embodiment, the upper platform has a rear wall which is hingedly connected to a rear edge of the platform. In a normal storage position, the rear wall is held in an upright vertical position while for purposes of embarking/disembarking, the back wall is lowered to an angle and retained thereat by retaining members. The ramps may then be hooked onto the back wall.

The sliding tray may take many different forms depending upon the ultimate usage of the same. Thus, it may be divided into various compartments for receiving tools and the like.

### BRIEF DESCRIPTION OF THE DRAWINGS

Having thus generally described the invention, reference will be made to the accompanying drawings illustrating embodiments thereof, in which:

FIG. 1 is a perspective view of a pick-up truck having one embodiment of a storage device according to the present invention;

FIG. 2 is a side elevational view thereof;

FIG. 3 is a cross sectional view taken along the lines 3-3 of FIG. 2;

FIG. 4 is a cross sectional view taken along the lines 4-4 of FIG. 3;

FIG. 5 is a perspective view of a further embodiment of a storage device according to the present invention; and

FIG. 6 is a perspective view showing an accessory ready to embark/disembark a recreational vehicle thereon.

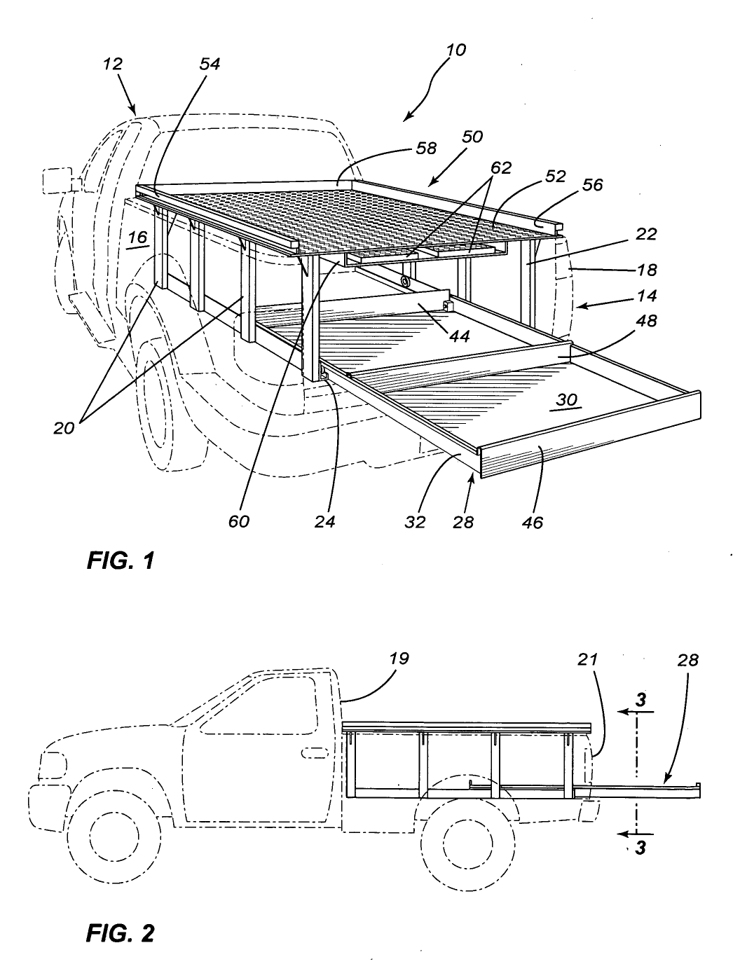

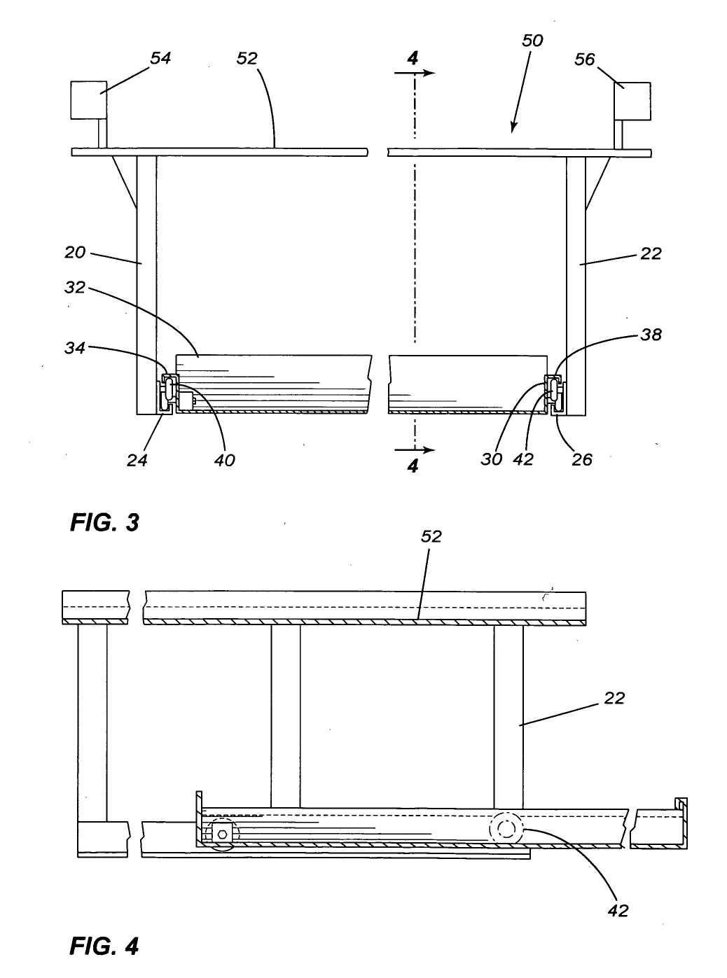

### DETAILED DESCRIPTION OF THE INVENTION

Referring to the drawings in greater detail and by reference characters thereto, there is illustrated a pick-up truck which is shown in dotted lines and generally designated by reference numeral 10. Pick-up truck 10 includes a cab portion 12 and a truck rear compartment 14 which is enclosed by first and second side walls 16, 18 respectively, a front wall 19 and a tailgate 21.

The device of the present invention includes a plurality of first side wall frame members 20 and a similar plurality of second side wall frame members 22. Extending along the bottom of first side wall frame members 20 and secured thereto is a first L-shaped track member 24. A second L-shaped track member 26 extends along and is secured to second side wall frame members 22.

A slidable tray generally designated by reference numeral 28 includes a bottom wall 30 along with first side wall 32 which has an outwardly extending flange 34. Similarly, a second side wall 36 includes an outwardly extending flange 38.

Mounted on first L-shaped track 24 are a plurality of first side wheels 40 which support tray 28 and wherein flange 34 rides thereon. Similarly, on the other side, there are provided second side wheels 42 to support flange 38 extending from second side wall 36.

Tray 28 also includes a front end wall 44 and a rear end wall 46. One or more divider walls 48 may be provided to separate the tray into various compartments for receiving tools and/or other accessories.

Mounted on the top of first side wall frame members 20 and second side wall frame members 22 is an upper platform generally designated by reference numeral 50. Upper platform 50 includes a floor portion 52 along with side rails 54 and 56. A front rail 58 also extends along the front portion of floor 52.

Located below floor 52 is a storage compartment 60 which is designed to receive ramps 62 for reasons which will become apparent hereinbelow.

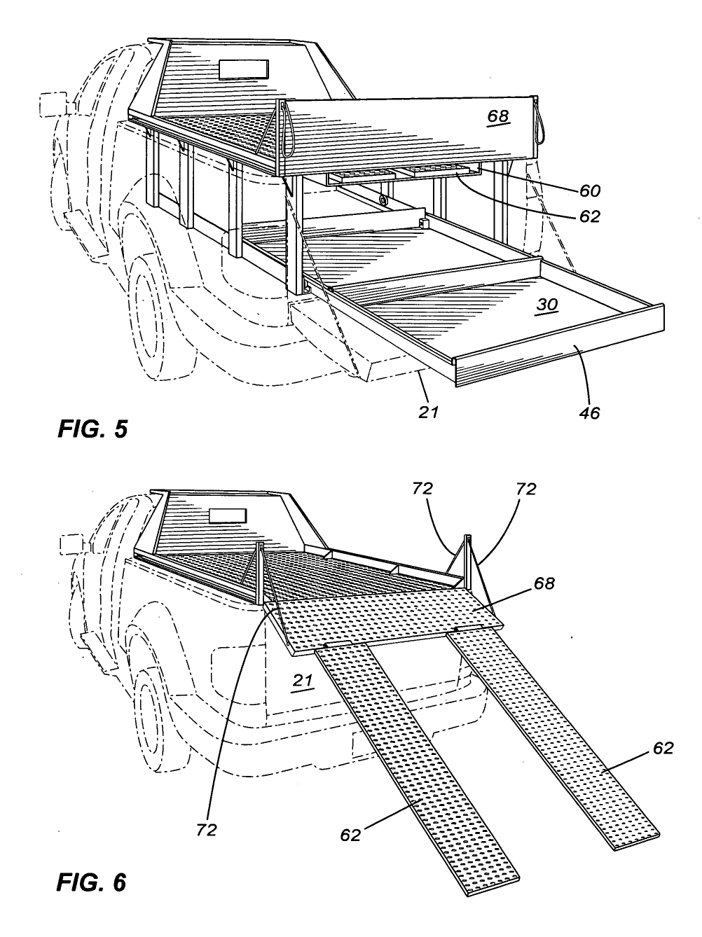

Turning to the embodiments of FIGS. 5 and 6, similar reference numerals are employed for similar components.

In this embodiment, upper platform 50 has, instead of a rail, a platform front wall 64 extending therefrom. An aperture 66 is provided therein to permit visibility through the rear window of the cab.

At the rear of upper platform 50, there is provided a hinged rear panel 68 which, in the position shown in FIG. 5, is suitable for retaining a recreational vehicle on the platform 50. However, when it is decided to embark/disembark as shown in FIG. 6, rear panel 68 is lowered and retaining members 72 support the rear panel 68. Ramps 62 may then be placed in position for embarking/disembarking the vehicle.

In a further embodiment, the floor 52 and/or side rails 54, 56 may be provided with apertures or the like or other places that jacks may be utilized to support and lift the device. Thus, one could provide the arrangement wherein rails 54 have a portion which extend outboard of the side walls 16 and 18 of the pick-up truck to permit lifting of the device at least to a height sufficient to allow the truck to drive out from underneath the same. A similar arrangement may be utilized for loading the device onto the pick-up truck.

It will be understood that the above described embodiments are for purposes of illustration only and that changes and modifications may be made thereto without departing from the spirit and scope of the invention.

I claim:

1. A storage device for a pick-up truck having an open pick-up bed, said storage device comprising:
a frame sized to fit within said pick-up bed;
an upper platform supported by said frame;
at least one ramp;
a storage compartment below said upper platform for storing said at least one ramp; and
a tray below said storage compartment, said tray being slidably moveable between a storage position and an open position.

2. The storage device of claim 1 wherein said upper platform has an upper platform rear end situated proximate a rear end of said pick-up truck, and a back wall hingedly connected to said upper platform rear end.

3. The storage device of claim 2 further including retaining means, said retaining means being designed to retain said back wall in a first position wherein said back wall extends perpendicularly upward, and a second position wherein said back wall extends downwardly and outwardly from said upper platform.

4. The storage device of claim 3 wherein said retaining means comprise first and second sets of cables, said first set of cables being arranged to retain said back wall in said first position and a second set of cables being adapted to retain said back wall in said downwardly and outwardly extending position.

5. The storage device of claim 1 further including a front wall located at a front end of said upper storage platform.

6. The storage device of claim 5 further including an aperture formed in said front wall to permit viewing therethrough.

7. The storage device of claim 1 further including side rails located on said upper platform at opposed sides thereof.

8. The storage device of claim 1 further including a track extending along a bottom portion of said frame on each side thereof, said tracks having wheels mounted thereon, said slidable tray being moveable along said wheels.
